(19) United States
(12) Patent Application Publication
(10) Pub. No.: US 2013/0141021 A1
(43) Pub. Date: Jun. 6, 2013

(54) MOTOR CONTROL CIRCUIT AND KEYBOARD ASSEMBLY HAVING SAME

(71) Applicants: YI-XIN TU, Shenzhen City (CN); SONG-LIN TONG, Shenzhen City (CN); QI-YAN LUO, Shenzhen City (CN); HAI-QING ZHOU, Shenzhen City (CN)

(72) Inventors: YI-XIN TU, Shenzhen City (CN); SONG-LIN TONG, Shenzhen City (CN); QI-YAN LUO, Shenzhen City (CN); HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/600,208

(22) Filed: Aug. 30, 2012

(30) Foreign Application Priority Data
Dec. 3, 2011 (CN) 201110395465.8

(51) Int. Cl. H02P 3/00

(52) U.S. Cl. 318/280

(57) ABSTRACT

An exemplary motor control circuit for controlling a motor includes a motor driving chip, a sensing unit, and a controller. The motor driving chip motor driving chip is electronically connected to the motor. The sensing unit includes a proximity sensor, the proximity sensor detects whether an external object is proximate to the proximity sensor. The controller is electronically connected to the motor driving chip and the sensing unit, the controller controls the motor driving chip to drive the motor to rotate in a first direction when an external object is detected, and controls the motor driving chip to drive the motor to rotate in a second direction reverse to the first direction when no external object is detected for a predetermined period of time.

### BACKGROUND

1. Technical Field

The disclosure generally relates to motor control circuits and keyboards; and particularly to a motor control circuit for controlling a rotational direction of a motor, and a keyboard assembly having the motor control circuit.

2. Description of Related Art

Computer keyboards are exposed to environmental contaminants, and are easily polluted by dust or other particles. A dust-proof keyboard may include a spindle, a flexible lid scrolled about the spindle, a motor for driving the spindle to rotate, and a button electronically connected to the motor. When the button is pressed, the motor drives the spindle to rotate to lay the flexible lid over the keyboard, whereby the flexible lid covers the keyboard to prevent the keyboard from being contaminated.

However, because the motor is controlled by the button, if a user forgets to press the button after using the keyboard, the keyboard is not covered by the flexible lid.

Therefore, there is room for improvement within the art.

### BRIEF DESCRIPTION OF THE DRAWINGS

Many aspects of the embodiments can be better understood with reference to the drawings. In the drawings, the emphasis is placed upon clearly illustrating the principles of the disclosure.

FIG. 1 is a block diagram of a keyboard assembly according to an exemplary embodiment, the keyboard assembly including a motor control circuit and a motor.

FIG. 2 is essentially a circuit diagram of the motor control circuit and motor shown in FIG. 1.

### DETAILED DESCRIPTION

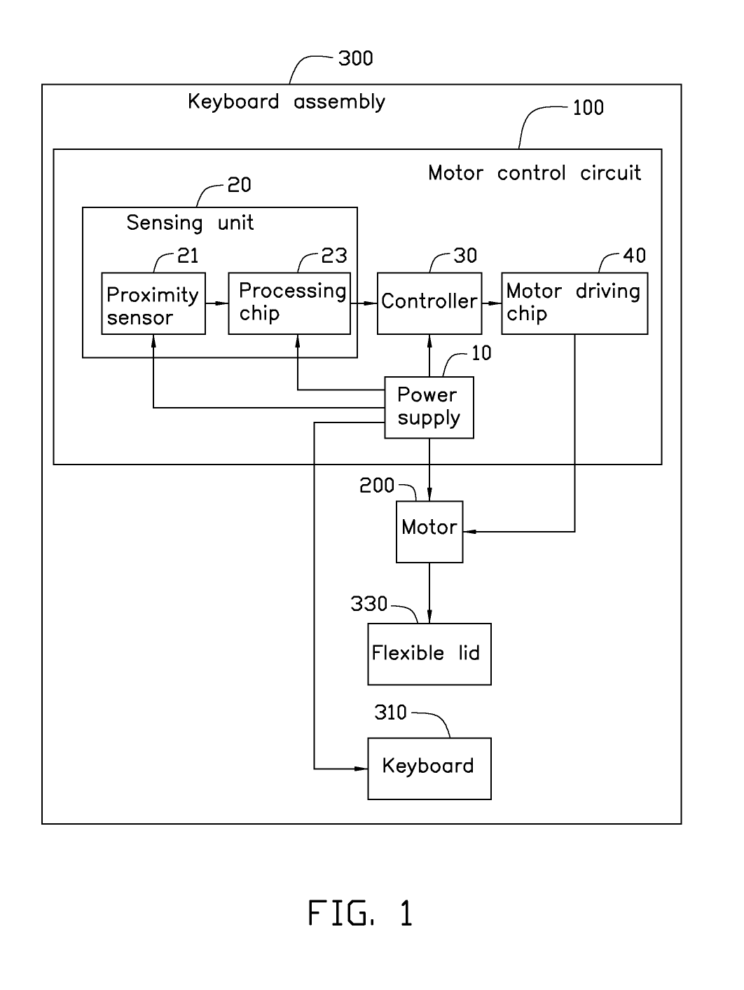

FIG. 1 is a block diagram of a keyboard assembly having a motor control circuit, according to an exemplary embodiment. The keyboard assembly 300 can be used in conjunction with a computer for example. The keyboard assembly 300 includes the motor control circuit 100, a motor 200, a keyboard 310, and a flexible lid 330 driven by the motor 200. The keyboard 310 has a plurality of keys arranged thereon. The motor control circuit 100 can control the motor 200 to rotate clockwise or counterclockwise. The flexible lid 330 is pulled up and withdrawn to expose the keyboard 310 when the motor 200 rotates in a first direction, e.g. a clockwise direction, under the control of the motor control circuit 100. The flexible lid 330 is pulled down to cover and shield a top surface of the keyboard 310 when the motor 200 rotates in a second direction reverse to the first direction, e.g. a counterclockwise direction, under the control of the motor control circuit 100. In the exemplary embodiment, the motor 200 is an electro-mechanical servo motor.

The motor control circuit 100 according to an exemplary embodiment includes a power supply 10, a sensing unit 20, a controller 30, and a motor driving chip 40. The power supply 10 powers the sensing unit 20, the controller 30, and the motor 200. The sensing unit 20 detects whether an external object, such as a human body part, is proximate to the keyboard 310, and outputs a control signal to the controller 30. The controller 30 controls the motor driving chip 40 to drive the motor 200 to rotate clockwise or counterclockwise according to the control signal.

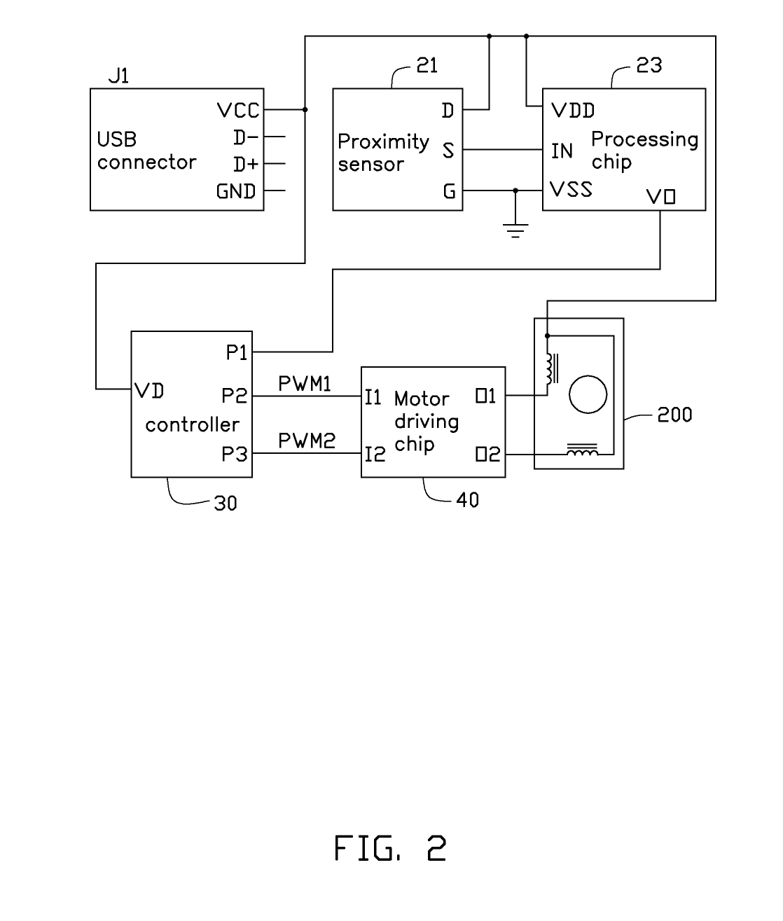

FIG. 2 is a circuit diagram of the motor control circuit 100 and motor 200. In the exemplary embodiment, the power supply 10 is supplied by a power supply unit of the computer through a power supply pin VCC of a Universal Serial Bus (USB) connector J1 of the keyboard 310. Hence, the power supply 10 seen in FIG. 1 is shown as the USB connector J1 in FIG. 2. The USB connector J1 is connected to another USB connector (not shown) of the computer. The keyboard 310 communicates with the computer through the USB connector J1; and all of the keyboard 310, the motor 200, the sensing unit 20, and the controller 30 receive their electrical power via the power supply pin VCC of the USB connector J1.

The sensing unit 20 includes a proximity sensor 21 mounted on the keyboard 310, and a processing chip 23 electronically connected to the proximity sensor 21. The proximity sensor 21 detects whether an external object is in the vicinity thereof, and thus detects whether the external object is in the vicinity of the keyboard 310. When an external object, such as a human body part, is in the vicinity of the proximity sensor 21, the proximity sensor 21 generates and transmits a detection signal to the processing chip 23. The proximity sensor 21 is preferred to be a pyroelectric infrared sensor. In one embodiment, the proximity sensor 21 is a RE200B type sensor made by NiceRa. The proximity sensor 21 has a power pin D, a signal output pin S, and a ground pin G. The ground pin G is grounded. The power pin D is electronically connected to the power pin VCC of the USB connector J1 to obtain power.

The processing chip 23 outputs a control signal following a detection signal received from the proximity sensor 21. Specifically, when the presence of an external object in the vicinity of the proximity sensor 21 is detected, the proximity sensor 21 outputs a detection signal to the processing chip 23. The detection signal has a small amplitude; therefore the processing chip 23 amplifies and filters the amplitude of the detection signal, and then outputs a modified signal. That is, the modified signal is output by the processing chip 23 as a control signal, to the controller 30. In the embodiment, the control signal is a high level signal (e.g. logic 1). Otherwise, when no external object in the vicinity of the proximity sensor 21 is detected for a predetermined period of time, the proximity sensor 21 stops outputting a detection signal to the processing chip 23. From that time, the processing chip 23 outputs a low level signal (e.g. logic 0) to the controller 30 as the control signal. In one embodiment, the processing chip 23 is a BISS0001 type made by Electronic Theatre Controls (ETC). The processing chip 23 includes a power pin VDD, a grounded ground pin VSS, an input pin IN electronically connected to the signal output pin S of the proximity sensor 21, and an output pin VO outputting the control signal. The power pin VDD is electronically connected to the power pin VCC of the USB connector J1 to obtain power.

The controller 30 has a power pin VD, a signal input pin P1, a first driving pin P2, and a second driving pin P3. The power pin VD is electronically connected to the power pin VCC of the USB connector J1 to obtain power. The signal input pin P1 is electronically connected to the output pin VO of the processing chip 23, to receive the control signal. Both of the first and second driving pins P2 and P3 are electronically connected to the motor driving chip 40, to respectively transmit a first controlling signal PWM1 and a second controlling signal PWM2 to the motor driving chip 70. In one embodiment, the first and second controlling signals PWM1 and PWM2 are in antiphase. When the controller 30 receives the control signal, the controller 30 changes the phase of the first and second controlling signals PWM1 and PWM2 appropriately.

The motor driving chip 40 includes a first input terminal I1 electronically connected to the first driving pin P2, a second input terminal I2 electronically connected to the second driving pin P3, a first output terminal O1 corresponding to the first input terminal I1, and a second output terminal O2 corresponding to the second input terminal I2. Both of the first and second output terminals O1 and O2 are electronically connected to the motor 200.

When an external object is detected, the controller 30 receives the control signal as a high level signal. Thereupon the first controlling signal PWM1 outputted from the controller 30 to the motor driving chip 40 is a first level signal (such as a high level signal), and the second controlling signal PWM2 outputted from the controller 30 to the motor driving chip 40 is a second level signal (such as a low level signal), and these signals cause the motor driving chip 40 to drive the motor 200 clockwise. Otherwise, when a predetermined prolonged absence of any external objects in the vicinity of the proximity sensor 21 is detected, the controller 30 receives the control signal as a low level signal. Accordingly, the first controlling signal PWM1 outputted from the controller 30 to the motor driving chip 40 is the second level signal (a low level signal), and the second controlling signal PWM2 outputted from the controller 30 to the motor driving chip 40 is the first level signal (a high level signal), and these signals cause the motor driving chip 40 to drive the motor 200 counterclockwise.

In everyday use of the keyboard assembly 300, the keyboard 310 is electronically connected to the computer via the USB connector J1. The controller 30, the proximity sensor 21, the processing chip 23, and the motor 200 are powered by the power supply unit of the computer via the USB connector J1. When an external object in the vicinity of the keyboard 310 is newly detected by the proximity sensor 21, the processing chip 23 outputs a control signal as a high level signal. Thereupon the controller 30 controls the motor driving chip 40 to drive the motor 200 clockwise, to cause the flexible lid 330 to withdraw or to be kept withdrawn so as to expose the keyboard 310. When no external object in the vicinity of the keyboard 310 is detected by the proximity sensor 21 for the predetermined period of time, the processing chip 23 outputs a control signal as a low level signal. Thereupon the controller 30 controls the motor driving chip 40 to drive the motor 200 counterclockwise, to pull and extend the flexible lid 330 over the keyboard 310 to protect the keyboard 310. Thus the motor control circuit 100 controls the rotation direction of the motor 200 according to the presence or timed-absence of an external object in the vicinity of the keyboard 310, so that the flexible lid 330 is automatically drawn across the keyboard 310 when the keyboard 310 is not in use. This provides much convenience for the user.

The exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments.

What is claimed is:

1. A motor control circuit for controlling rotation directions of a motor, comprising:
a motor driving chip electronically connected to the motor;
a sensing unit comprising a proximity sensor, the proximity sensor detecting whether an external object is proximate to the proximity sensor; and
a controller electronically connected to the motor driving chip and the sensing unit, the controller controlling the motor driving chip to drive the motor to rotate in a first direction when an external object is detected, and controlling the motor driving chip to drive the motor to rotate in a second direction reverse to the first direction when no external object is detected for a predetermined period of time.

2. The motor control circuit of claim 1, wherein the sensing unit further comprises a processing chip electronically connected to the proximity sensor and the controller, and the processing chip outputs control signals to the controller according to the presence or absence of detection signals transmitted by the proximity sensor to the processing chip.

3. The motor control circuit of claim 2, wherein when an external object is detected, the proximity sensor outputs a detection signal to the processing chip, and the processing chip amplifies and filters the amplitude of the detection signal and outputs the modified signal to the controller as a control signal.

4. The motor control circuit of claim 3, wherein when the external object is detected, the processing chip outputs a high level signal to the controller as the control signal; and when no external object is detected for the predetermined period of time, the processing chip outputs a low level signal to the controller as a control signal.

5. The motor control circuit of claim 1, further comprising a universal serial bus (USB) connector electronically connected to a computer, wherein the controller, the sensing unit, and the motor are powered by the computer via the USB connector.

6. The motor control circuit of claim 1, wherein the proximity sensor is a pyroelectric infrared proximity sensor.

7. A keyboard assembly, comprising:
a keyboard;
a flexible lid mounted to the keyboard;
a motor configured for driving the flexible lid to be withdrawn or be extended; and
a motor control circuit configured for controlling rotation directions of the motor, comprising:
a motor driving chip electronically connected to the motor;
a sensing unit comprising a proximity sensor, the proximity sensor detecting whether an external object is proximate to the proximity sensor; and
a controller electronically connected to the motor driving chip and the sensing unit, the controller controlling the motor driving chip to drive the motor to rotate in a first direction when an external object is detected, and controlling the motor driving chip to drive the motor to rotate in a second direction reverse to the first direction when no external object is detected for a predetermined period of time;
wherein the flexible lid is withdrawn to expose the keyboard when the motor rotates in the first direction, and the flexible lid is extended to cover the keyboard when the motor rotates in the second direction.

8. The keyboard assembly of claim 7, wherein the proximity sensor is mounted on the keyboard.

9. The keyboard assembly of claim 7, wherein the sensing unit further comprises a processing chip electronically connected to the proximity sensor and the controller, and the processing chip outputs control signals to the controller according to the presence of absence of detection signals transmitted by the proximity sensor to the processing chip.

10. The keyboard assembly of claim 9, wherein when an external object is detected, the proximity sensor outputs a detection signal to the processing chip, and the processing chip amplifies and filters the amplitude of the detection signal and outputs the modified signal to the controller as a control signal.

11. The keyboard assembly of claim 10, wherein when the external object is detected, the processing chip outputs a high level signal to the controller as the control signal; and when no external object is detected for the predetermined period of time, the processing chip outputs a low level signal to the controller as a control signal.

12. The keyboard assembly of claim 7, further comprising a universal serial bus (USB) connector electronically connected to a computer, wherein the keyboard communicates with computer through the USB connector, and the keyboard, the controller, the sensing unit, and the motor are powered by the computer via the USB connector.

13. The keyboard assembly of claim 7, wherein the proximity sensor is a pyroelectric infrared proximity sensor.

14. A motor control circuit for controlling rotation directions of a motor, comprising:
a motor driving chip electronically connected to the motor;
a sensing unit comprising a proximity sensor; the proximity sensor detecting whether an external object is in the vicinity thereof; and the sensing unit outputting different control signals, according to whether an external object is detected, or whether no external object is detected for a predetermined period of time; and
a controller electronically connected to the motor driving chip and the sensing unit, the controller controlling the motor driving chip to drive the motor to rotate in a first direction when the presence of an external object in the vicinity of the proximity sensor is detected, and controlling the motor driving chip to drive the motor to rotate in a second direction reverse to the first direction when no external object in the vicinity of the proximity sensor is detected for the predetermined period of time.

15. The motor control circuit of claim 14, wherein the sensing unit further comprises a processing chip electronically connected to the proximity sensor and the controller, and the processing chip outputs the control signals to the controller according to the presence or absence of detection signals transmitted by the proximity sensor to the processing chip.

16. The motor control circuit of claim 15, wherein when the external object in the vicinity of the proximity sensor is detected, the proximity sensor outputs a detection signal to the processing chip, and the processing chip amplifies and filters the amplitude of the detection signal, and outputs the modified signal to the controller as a control signal.

17. The motor control circuit of claim 16, wherein the external object in the vicinity of the proximity sensor is detected, the processing chip outputs a high level signal to the controller as the control signal; and when no external object in the vicinity of the proximity sensor is detected for the predetermined period of time, the processing chip outputs a low level signal to the controller as a control signal.

18. The motor control circuit of claim 14, further comprising a universal serial bus (USB) connector electronically connected to a computer, wherein the controller, the proximity sensor, and the motor are powered by the computer via the USB connector.

19. The motor control circuit of claim 14, wherein the proximity sensor is a pyroelectric infrared proximity sensor.
